(19) United States
(12) Patent Application Publication
(10) Pub. No.: US 2011/0064982 A1
(43) Pub. Date: Mar. 17, 2011

(54) FIXING MECHANISM

(75) Inventor: ZHI-HUA LIU, Shenzhen City (CN)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/607,228

(22) Filed: Oct. 28, 2009

(30) Foreign Application Priority Data
Sep. 14, 2009 (CN) 200910306969.0

(51) Int. Cl. H01M 2/10

(52) U.S. Cl. 429/100

(57) ABSTRACT

A fixing mechanism includes a battery cover, a latching member fixed to the battery cover, and a battery sleeve. The latching member includes a limiting protrusion and a latching protrusion adjacent to the limiting protrusion. The battery sleeve defines an open end to receive a battery. The battery sleeve further includes a limiting portion defined in an inner surface thereof adjacent to the open end, and a latching portion defined in the inner surface thereof below the limiting portion. The battery cover and the latching member rotatably engage with the battery sleeve to seal the open end. The latching protrusion is movably locked in the latching portion and the rotation of the limiting protrusion is limited by the limiting portion.

### BACKGROUND

1. Technical Field

The present disclosure generally relates to fixing mechanisms and, particularly, to a fixing mechanism for a battery in an electronic device.

2. Description of Related Art

An electronic device, such as a wireless keyboard, a wireless touchpad, a remote control, or other battery operated device often utilizes a battery to provide electrical power. A fixing mechanism for a battery in the electronic device is often utilized to facilitate insertion and removal of the battery.

A typical fixing mechanism includes a battery sleeve and a detachable battery cover. The battery sleeve defines an open end. The sleeve defines a chamber to receive the battery via the open end. The battery cover includes a cover plate and a body portion extending downward from the cover plate. The battery sleeve further defines an inner threading in an inner surface of the chamber adjacent to the open end. The body portion of the battery cover defines an outer threading corresponding to the inner threading, such that the body portion of the battery cover may engage the open end of the battery sleeve. However, this system is relatively inconvenient to use.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views, and all the views are schematic.

FIG. 1 is an assembled, partial isometric view of a first embodiment of a fixing mechanism.

FIG. 2 is an exploded, partial isometric view of the fixing mechanism of FIG. 1.

FIG. 3 is a cross-section of the fixing mechanism of FIG. 1, taken along line III-III.

FIG. 4 is a cross-section of the fixing mechanism of FIG. 1, taken along line IV-IV.

FIG. 5 is a partial isometric view of a battery sleeve of a second embodiment of a fixing mechanism.

### DETAILED DESCRIPTION

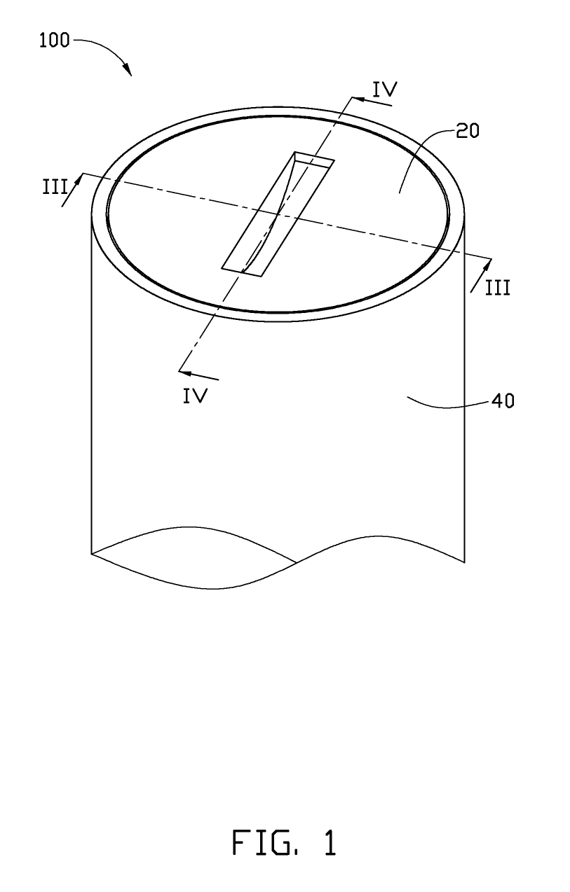

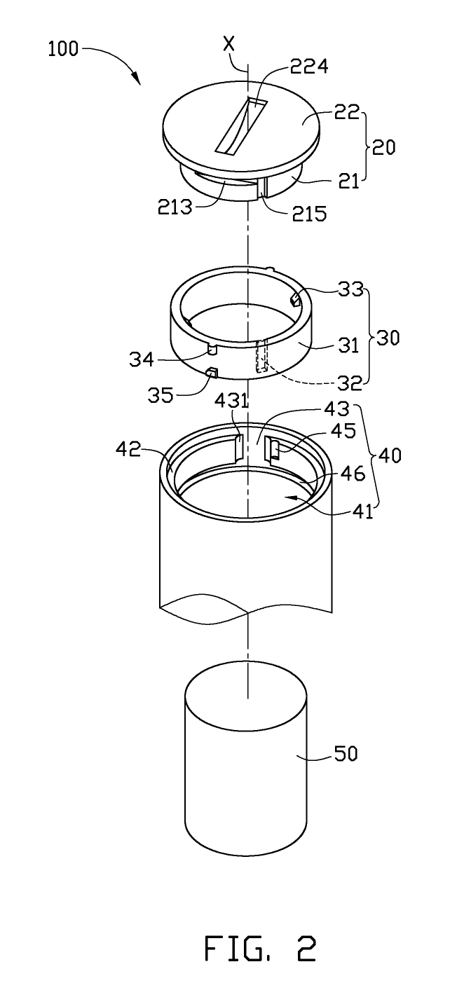

Referring to FIGS. 1 and 2, a first embodiment of a fixing mechanism 100 includes a battery cover 20, a latching member 30 and a battery sleeve 40. The latching member 30 is fixed to the battery cover 20. The battery cover 20 is fixed to the battery sleeve 40 via the latching member 30. The fixing mechanism 100 is used to fix a battery 50 in the battery sleeve 40 with the battery cover 20 and the latching member 30. The fixing mechanism 100 can be employed in an electronic device (not shown), such as a wireless keyboard, a wireless touchpad, or a remote control.

The battery cover 20, the latching member 30, and the battery sleeve 40 define a common central axis X (see FIG. 2). The battery cover 20 includes a body portion 21 and a cover portion 22 formed at an end of the body portion 21. The body portion 21 is substantially cylindrical. The cover portion 22 is a substantially circular plate. A diameter of the cover portion 22 exceeds a diameter of the body portion 21. The battery cover 20 further includes two elongated latching grooves 213 in an outer surface of the body portion 21 adjacent to the cover portion 22. The two elongated latching grooves 213 are symmetric relative to the central axis X. The elongated latching grooves 213 extend along a circumference substantially perpendicular to the central axis X. The battery cover 20 further includes a guiding slot 215 defined in the outer surface of the body portion 21 extending substantially parallel to the central axis X adjacent to one of the latching grooves 213. The battery cover 20 can be made of electrical conductive metals.

The latching member 30 can be substantially annular. The latching member 30 includes an annular main body 31, a guiding protrusion 32, two resilient hooks 33, two limiting protrusions 34, and two latching protrusions 35. The guiding protrusion 32 is defined at an inner surface of the annular main body 31 corresponding to the guiding slot 215 of the battery cover 20. The resilient hooks 33 are separately formed at the inner surface of the annular main body 31 corresponding to the latching grooves 213 of the battery cover 20. The guiding protrusion 32 can be received in the guiding slot 215 and the resilient hooks 33 engage with the latching grooves 213, such that the latching member 30 is fixed to the body portion 21 of the battery cover 20.

The limiting protrusions 34 are separately formed at one end of an outer surface of the annular main body 31. The latching protrusions 35 are separately formed at the other end of the outer surface of the annular main body 31 corresponding to the limiting protrusions 34. In the illustrated embodiment, the limiting protrusions 34 are symmetrical relative to the central axis X. One of the limiting protrusions 34 and one of the latching protrusions 35 adjacent to the one of the limiting protrusion 34 are aligned substantially parallel to the central axis X at two ends of the annular main body 31. The latching member 30 can be made of plastic materials.

The battery sleeve 40 can be substantially cylindrical. The battery sleeve 40 defines an open end 41. The battery sleeve 40 is configured to receive a battery 50 (see FIG. 2) via the open end 41. The battery sleeve 40 further includes a ledge 42, two guiding portions 43, two limiting portions 45 and a latching portion 46. The ledge 42 is defined at an inner surface of the battery sleeve 40 at the open end 41. The latching portion 46 is defined in the inner surface of the battery sleeve 40 away from the open end 41 and apart from the ledge 42. The latching portion 46 extends along a circumference substantially perpendicular to the central axis X. Each guiding portion 43 is defined in the inner surface of the battery sleeve 40 and interconnects the ledge 42 and the latching portion 46. Each limiting portion 45 is defined in the inner surface of the battery sleeve 40 adjoining a side of each guiding portion 43.

In the illustrated embodiment, the ledge 42 is a continuous cutout extending along a circumference substantially perpendicular to the central axis X to block the cover portion 22 of the battery cover 20. The latching portion 46 is a continuous slot extending along a circumference substantially parallel to the ledge 42. Each guiding portion 43 is an elongated depression communicating with the ledge 42 and the latching portion 46. The two guiding portions 43 are symmetrical relative to the central axis X corresponding to the two pairs of the limiting protrusions 34 and the latching protrusions 35. Each limiting portion 45 is an elongated depression defined in the inner surface of the battery sleeve 40 extending substantially parallel to the central axis X, and communicates with each guiding portion 43. It should be pointed out that, in an alternative embodiment, the ledge 42 can be omitted, with the cover portion 22 of the battery cover 20 blocked by an end of the battery sleeve 40.

The body portion 21 and the latching member 30 can be rotatably engaged with the battery sleeve 40 to seal the open end 41, and the cover portion 22 blocked by the ledge 42 of the battery sleeve 40. The latching protrusion 35 is movably locked in the latching portion 46 and the limiting protrusion 34 is received in the limiting portion 45 so as to be limited in rotation by the limiting portion 45. The battery cover 20 may further define an elongated mounting depression 224 in an upper surface of the cover portion 22, rotatable by a screwdriver or other tool to assemble or disassemble the battery cover 20 to the battery sleeve 40.

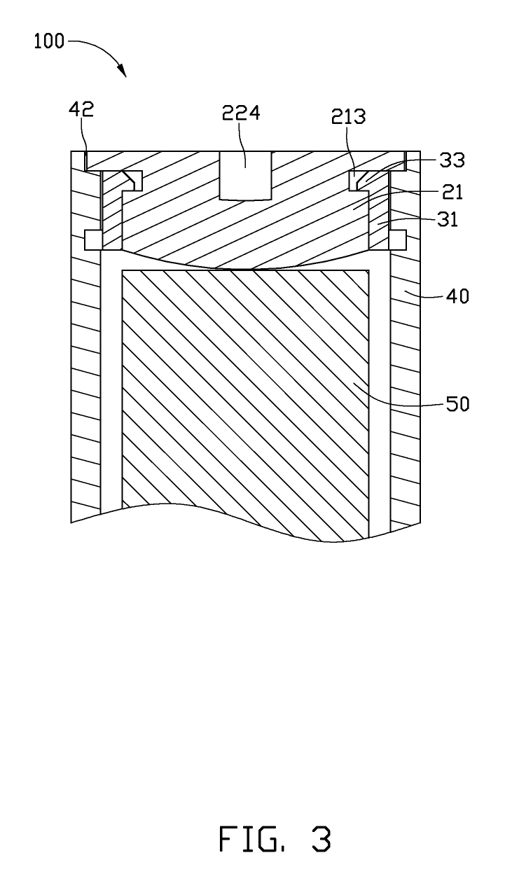

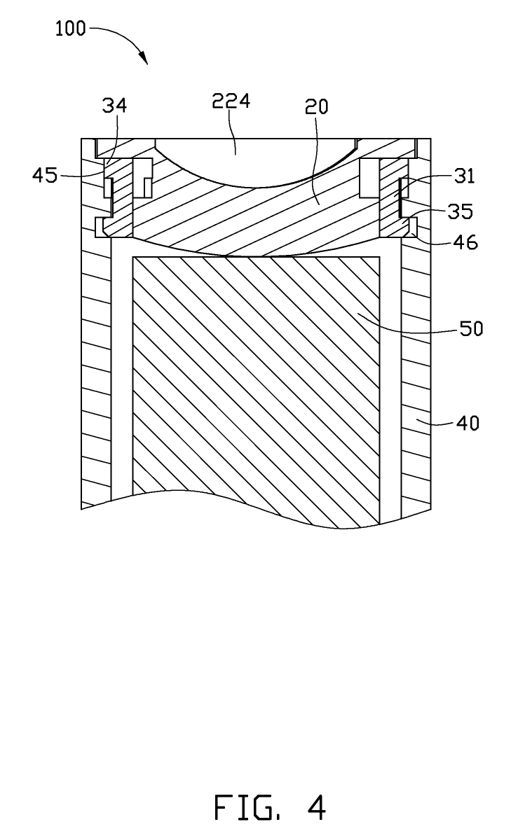

Referring to FIGS. 2 through 4, to fix the battery cover 20 and the latching member 30 to the battery sleeve 40, the guiding protrusion 32 is first received in the guiding slot 215 by the latching member 30 moving from the body portion 21 toward the cover portion 22, until the resilient hooks 33 engage with the latching grooves 213, such that the latching member 30 is fixed to the body portion 21 of the battery cover 20. Two pairs of the latching protrusion 35 and the limiting protrusion 34 in a line substantially parallel to the central axis X, then slide into the battery sleeve 40 along the two guiding portions 43 respectively, until contacting the latching portion 46. Next, the battery cover 20 is rotated clockwise, the latching protrusion 35 is locked in the latching portion 46 and the limiting protrusion 34 is received in the limiting portion 45 and thereby limited. Accordingly, the battery cover 20 and the latching member 30 are fixed to the battery sleeve 40.

To disassemble the battery cover 20 with the latching member 30 from the battery sleeve 40, the battery cover 20 is first rotated counter-clockwise. The latching protrusions 35 are then moved to a portion facing the guiding portions 43, and the limiting protrusions 34 are detached from the limiting portions 45. Finally, the battery cover 20 with the latching member 30 is freed from the battery sleeve 40.

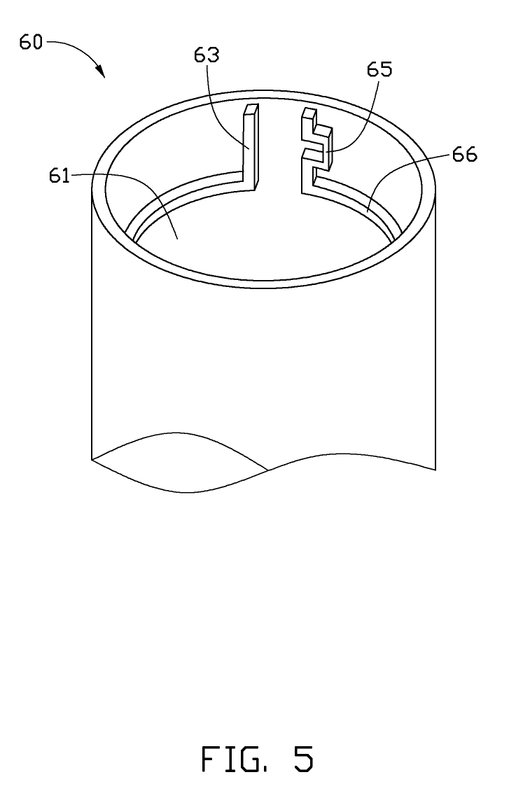

Referring to FIG. 5, in a second embodiment, a battery sleeve 60 includes two guiding portions 63, two limiting portions 65 and a latching portion 66. Each guiding portion 63 may be an elongated protrusion extending from an inner surface of the battery sleeve 60 substantially parallel to the central axis X adjacent to an open end 61. The latching portion 66 may be a protrusion extending from the inner surface of the battery sleeve 60 along a circumference substantially perpendicular to the central axis X. Each limiting portion 65 is a substantially C-shaped structure, two ends of which extend from a part of each guiding portion 63.

In the illustrated embodiment, the latching protrusions 35 of the latching member 30 may slide into the battery sleeve 60 along the corresponding guiding portion 63 until the latching protrusions 35 is just below the latching portion 66. The battery cover 20 is then rotated clockwise, whereby the limiting protrusion 34 of the latching member 30 is received in the limiting portion 65, thereby rotation is limited by the limiting portion 45. Accordingly, the battery cover 20 and the latching member 30 can be fixed to the battery sleeve 60.

It should be noted that the battery cover 20 and the latching member 30 can be integrally formed to an integral structure. In an alternative embodiment, all of the elongated latching grooves 213, the guiding slot 215, the resilient hooks 33, and the guiding protrusion 32 can be omitted, as long as the latching member 30 is fixed to the battery cover 20 by adhesive.

It should be noted that the configurations of the guiding portions 43, 63, the latching protrusions 35, and limiting protrusions 34 are not limited to the embodiments described above. The numbers and shapes of the guiding portions 43, 63, the latching protrusions 35, and limiting protrusions 34 are specifically described and illustrated for the purpose of exemplifying various aspects of the present fixing mechanism 100.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. A fixing mechanism, comprising:
a battery cover;
a latching member fixed to the battery cover, the latching member comprising a limiting protrusion and a latching protrusion adjacent to the limiting protrusion;
a battery sleeve defining an open end to receive a battery, the battery sleeve comprising a limiting portion defined in an inner surface thereof adjacent to the open end, and a latching portion defined in the inner surface thereof below the limiting portion, wherein the latching member is rotatably engaged with the battery sleeve via the open end, the latching protrusion is movably locked in the latching portion, and rotation of the limiting protrusion is limited by the limiting portion.

2. The fixing mechanism of claim 1, wherein the battery cover comprises a body portion and a cover portion formed at an end thereof.

3. The fixing mechanism of claim 2, wherein the battery cover further comprises two elongated latching grooves in an outer surface of the body portion adjacent to the cover portion, and a guiding slot defined in the outer surface of the body portion extending substantially parallel to a central axis thereof adjacent to one of the latching grooves.

4. The fixing mechanism of claim 3, wherein the two elongated latching grooves are symmetric relative to the central axis and extend along a circumference substantially perpendicular to the central axis.

5. The fixing mechanism of claim 3, wherein the latching member further comprises an annular main body, a guiding protrusion defined at an inner surface of the annular main body corresponding to the guiding slot of the battery cover, and two resilient hooks separately formed at the inner surface of the annular main body corresponding to the latching grooves of the battery cover; the guiding protrusion is received in the guiding slot and the resilient hooks engage with the latching grooves, such that the latching member is fixed to the body portion of the battery cover.

6. The fixing mechanism of claim 5, wherein the limiting protrusion is formed at a first end of an outer surface of the annular main body; the latching protrusion is formed at a second end of the outer surface of the annular main body corresponding to the limiting protrusion; the limiting protrusion and the latching protrusion are aligned substantially parallel to the central axis.

7. The fixing mechanism of claim 1, wherein the latching portion is defined in an inner surface of the battery sleeve away from the open end, and extends along a circumference substantially perpendicular to a central axis of the battery sleeve.

8. The fixing mechanism of claim 7, wherein the latching portion is a continuous slot.

9. The fixing mechanism of claim 7, wherein the limiting portion is an elongated depression defined in the inner surface of the battery sleeve extending substantially parallel to the central axis.

10. The fixing mechanism of claim 2, wherein the battery sleeve further comprises a ledge defined at an inner surface thereof at the open end, the ledge extending along a circumference substantially perpendicular to a central axis thereof to block the cover portion of the battery cover.

11. The fixing mechanism of claim 10, wherein the battery sleeve further comprises a guiding portion defined in the inner surface thereof adjacent to the limiting portion and interconnecting the ledge and the latching portion.

12. The fixing mechanism of claim 11, wherein the guiding portion is an elongated protrusion extending from the inner surface of the battery sleeve substantially parallel to the central axis of the battery sleeve adjacent to an open end.

13. The fixing mechanism of claim 12, wherein the limiting portion is a substantially C-shaped structure, wherein two ends of the limiting portion extend from a part of each guiding portion.

14. The fixing mechanism of claim 1, wherein the latching portion is a protrusion extending from the inner surface of the battery sleeve along a circumference substantially perpendicular to the central axis of the battery sleeve.

15. The fixing mechanism of claim 1, wherein the battery cover is made of electrically conductive metals and the latching member is made of plastic.
